(19) United States
(12) Patent Application Publication
(10) Pub. No.: US 2002/0062395 A1
(43) Pub. Date: May 23, 2002

(54) Browser and network optimization systems and methods

(76) Inventors: David Thompson, Austin, TX (US); Dennis Parker, Leander, TX (US)

Correspondence Address: H. Dale Langley, Jr., The Law Firm of H. Dale Langley, Jr., P.C., 610 West Lynn, Austin, TX, 78703, US

(21) Appl. No.: 09/981,635

(22) Filed: Oct. 17, 2001

Related U.S. Application Data
(60) Provisional application No. 60/240,985, filed on Oct. 17, 2000.
(60) Provisional application No. 60/177,329, filed on Jan. 21, 2000.
(60) Provisional application No. 60/180,649, filed on Feb. 7, 2000.
(60) Provisional application No. 60/220,730, filed on Jul. 26, 2000.
(60) Provisional application No. 60/241,096, filed on Oct. 17, 2000.
(60) Provisional application No. 60/241,095, filed on Oct. 17, 2000.
(60) Provisional application No. 60/241,086, filed on Oct. 17, 2000.
(60) Provisional application No. 60/241,087, filed on Oct. 17, 2000.

(51) Int. Cl. G06F 15/16

(52) U.S. Cl. 709/246; 709/219

(57) ABSTRACT

A server computer, such as for a wireless application service provider, connected to a network, for example, the Internet, prioritizes transmissions according to data types. The server computer includes a parser and respective queues for each of the different data types. The server computer, for example, receives a Web page, parses it to segregate data types of the page, and stores the separate data types in distinct and segregated queues. In transmissions to a client device, for example, a wireless device communicating with the server computer over a wireless channel, the server computer sends the data in sequence from the respective queues, according to a prioritized sequence set at the server computer. A server computer, such as of the wireless application service provider, alternatively or additionally communicates with the client device, such as the wireless device, a smaller amount of information than requested by the client device and received by the server computer. At the server computer, the information is pre-processed and data sequences of the information are replaced with defined identifiers. Only the information with the defined identifiers substituted for the data sequences is communicated by the server computer to the client device. The client device, on receiving such reduced quantity of information, re-constructs the original information by substituting back the data sequences for the defined identifiers.

### CROSS-REFERENCE TO RELATED APPLICATIONS

The present application is related to U.S. patent application (CPA) Ser. No. 08/852,557, entitled “Remote Digital Image Viewing System and Method”, filed May 7, 1997 (CPA filed Oct. 26, 1999); U.S. Provisional Patent Application No. 60/177,329, entitled “Wireless Network System and Method”, filed Jan. 21, 2000; U.S. Provisional Patent Application No. 60/180,649, entitled “Digital Image Transfer System and Method”, filed Feb. 7, 2000; and U.S. Provisional Patent Application No. 60/220,730, entitled “Wireless Network System and Method”, filed Jul. 26, 2000, each of the same inventor hereof, and those respective applications are incorporated herein. The present application is also related to U.S. Provisional Patent Application No. 60/241,096, entitled “Wireless ASP Systems and Methods,” filed Oct. 16, 2000, U.S. Provisional Patent Application No. 60/241,095, entitled “E-Mail and Messaging Systems and Methods,” filed Oct. 16, 2000, U.S. Provisional Patent Application No. 60/241,086, entitled “Wireless Communications Invisible Proxy and Hooking Systems and Methods,” filed Oct. 16, 2000, and U.S. Provisional Patent Application No. 60/241,087, entitled “Wireless Communications Protocols and Architectures Systems and Methods,” filed Oct. 16, 2000.

### BACKGROUND OF THE INVENTION

The present invention generally relates to data communications systems and methods and, more particularly, relates to systems and methods for wireless packetized data communications with optimized sending and receiving according to data types and content, such as in a Web page or other multi-data type files and information.

Conventional packetized data communications over wireless networks typically have conformed to the same protocols and formats as employed over wired networks. The dynamics and conditions of wireless channels, however, differ quite significantly from those of wired environments. Moreover, bandwidths and communications speeds in wireless networks are typically less efficient and slower than in wired systems.

It would be a significant improvement in the art and technology to provide systems and methods for optimizing packetized data communications according to data types and priority choices among various information, for example, with a Web page or other data files or information over the Internet, particularly in wireless networks and communications.

### SUMMARY OF THE INVENTION

An embodiment of the invention is communications network for communicating an information comprised of at least one data type. The network includes a parser for parsing the information into distinct ones of each of the at least one data type and queue for storing each distinct one of the at least one data type.

Another embodiment of the invention is a method of prioritizing information communications according to data types of the information. The method includes receiving the information and parsing the information to separate and segregate data types. In other aspects, the method also includes saving the separate data types in respective queues and sending the information in a prioritized sequence via the respective queues.

Yet another embodiment of the invention is a method of communications. A client device communicates with a server computer over a network. The method includes receiving an information by the server computer, pre-processing the information by replacing sequences of data of the information with pre-defined identifiers, and sending the information with the pre-defined identifiers substituted for the sequences of data.

Another embodiment of the invention is a server computer for receiving information including data sequences and for relating data sequences to defined identifiers. The server computer includes a pre-processor for replacing data sequences of the information with defined identifiers.

### BRIEF DESCRIPTION OF THE DRAWINGS

The present invention is illustrated by way of example and not limitation in the accompanying figures, in which like references indicate similar elements, and in which:

FIG. 1 illustrates a network, for example, the Internet, including a wireless communications portion and a wireless application service provider (ASP) system including a wireless ASP server computer in wireless communications with a wireless device;

FIG. 2 illustrates a parser of a server computer for distinguishing and segregating data types of information received by the server communication, for prioritized communications according to data types to a client device;

FIG. 3 illustrates a method of operation of the parser and server computer of FIG. 2, according to embodiments of the present invention;

FIG. 4 illustrates a pre-processor of a server computer for replacing data sequences with defined identifiers to reduce a size of information to be communicated by the server computer to a client device, according to embodiments of the present invention;

FIG. 5 illustrates a method of operation of the pre-processor and server computer of FIG. 4, according to embodiments of the present invention.

### DETAILED DESCRIPTION OF PREFERRED EMBODIMENTS

### Network with Wireless ASP System

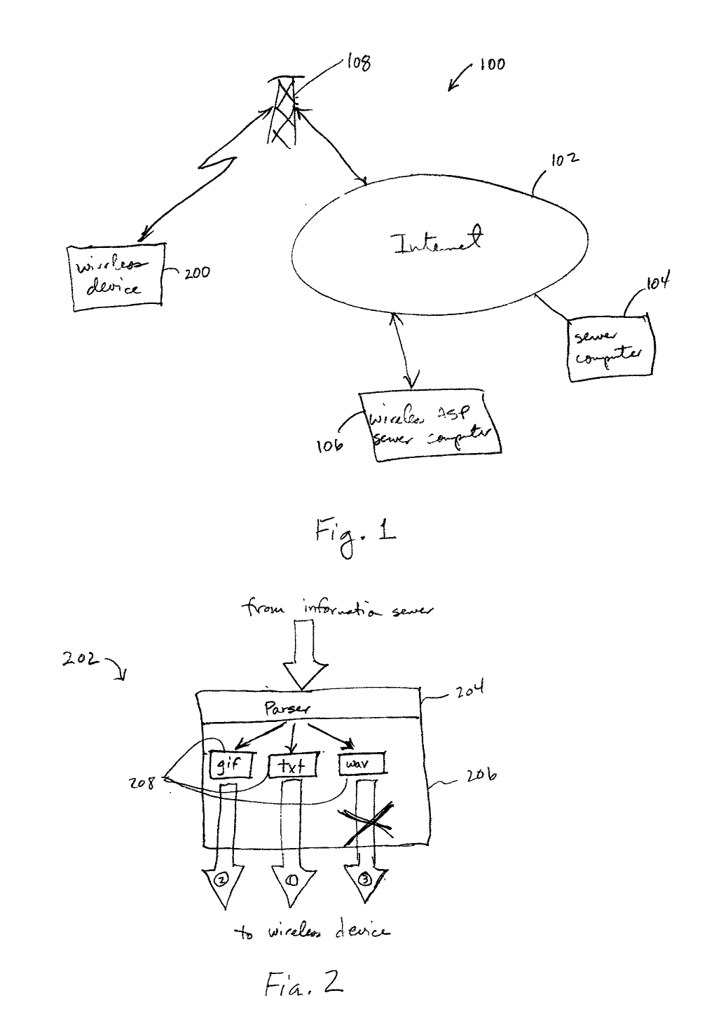

Referring to FIG. 1, a communications system 100 includes a wireless communications portion and a wired communications portion. The system 100 includes a network, such as the Internet 102. The network is operable according to a particular packetized data protocol, such as transport control protocol/Internet protocol (TCP/IP) or some other network protocol. The network, such as the Internet 102, interconnects various computing and communications devices, for example, among other devices, a server computer 104 and a wireless ASP server computer 106. The server computer 104 and the wireless ASP server computer 106 are each one or more server computers including a microprocessor, memory storage, and communications capabilities via wire or wireless connection with the Internet 102. The server computer 104 and the wireless ASP server computer 106 communicate over the Internet 102 or other network via the particular protocol of the network, such as the standard Internet network protocol TCP/IP.

The network, such as the Internet 102, is also connected with a wireless communications service provider 108. The wireless communications service provider 108 is, for example, a cellular or other packetized data wireless communications network. The wireless service provider 108 connects by wire connection with the network, such as the Internet 102. Alternatively, the wireless communications service provider 108 could connect with the network 102 by other communications connection, such as fiber optic, coax cable, wireless channel, or other communications connection. Furthermore, although the wireless communications service provider 108 is illustrated as a single particular communications channel, multiple links and multiple channels of those links, for example, communications links of wired and wireless channels, can alternatively provide the same functions and are included for purposes of the description.

The wireless service provider 108 is capable of communicating through wireless channels with various devices, such as a wireless device 200. The wireless device 200 is a processing device, such as a data-enabled cellular telephone, a personal digital assistant, a laptop computer, or any of a wide variety of other processing devices that can wirelessly communicate with the wireless service provider 108. Of course, the wireless device 200 includes communications equipment for accomplishing the wireless communication with the wireless service provider 108, such as wireless modem.

The wireless device 200 communicates through the wireless service provider 108 and over the network, such as the Internet 102, with the wireless ASP server computer 106. The wireless ASP server computer 106 serves as a dedicated server for the wireless device 200 in its communications. The wireless ASP server computer 106 sends and receives communications to and from the wireless device 200 over the network, such as the Internet 102, and on through the wireless service provider 108. The wireless ASP server computer 106 also communicates over the network, such as the Internet 102, with other network connected devices, such as the server computer 104, via particular protocols in communications channels enabled for such communications on the network. In certain embodiments, for example, the wireless ASP server computer 106 and the wireless device 200 communicate with specialized protocols, such as optimized packetized data protocols, for example, optimized TCP/IP protocols or other protocols such as described in the related patent applications.

### Content-Based Prioritization

Referring to FIG. 2, a content-based priority server 202, for example, the wireless ASP server computer 106 of FIG. 1, includes a parser 204 and various data-type queues 208. The parser 204 is implemented in a hardware or software of the server 202. Incoming communications to the server 202, such as from another device of the network, for example, the server computer 104, are processed by the parser 204. The parser 204 distinguishes and determines the data type or types of the incoming communications. The data is then separately segregated and stored, according to respective data type, in the queues 208. For example, the queues 208 each hold separate files of data types of information received over the network, such as separate .gif, .txt, .html, .wav and so forth files in Web pages.

In operation, information is received over the network, such as the Internet 102, by the wireless ASP server computer 106. The information is delivered in communications from other servers and elements of the network, for example, the server computer 104 can deliver information to the wireless ASP server computer 106 corresponding to information requests of the wireless device 200 in communication with the wireless ASP server computer 106. At the wireless ASP server computer 106, the parser 204 parses the information received and segregates the various data types of the information in the queues 208. The wireless ASP server computer 106 then can perform various manipulations with the information as segregated in the queues 208. For example, certain of the data types of the queues 208 can be discarded by the wireless ASP server computer 106. Alternatively, various prioritizations can be made by the wireless ASP server computer 106 by prioritizing the queues 208. In certain embodiments, the wireless ASP server computer 106 can send data of the separate queues 208 in desired sequence, for example, by prioritizing text transmissions over image transmissions, and so forth.

Referring to FIG. 3, a method 300 is performed by the content-based priority server 202. In a step 302, the priority server 202 receives information communicated to the server 202 over the network. The information is communicated to the priority server 202 acting as a proxy, as the information is requested by a device served by the server 202, such as the wireless device 200. The priority server 202 serves the information to the requesting device, such as by wireless channels to the wireless device 200. The information is any of a variety of information that can be served to or otherwise maintained and located on the server 202, such as a Web page including text, images, and possibly other files of varied data types. The entire information, that is, all data including the various data types of the information, is received by the server 202 in the step 302.

In a step 304, the server 202, via software or hardware of the server 202 or a device or peripheral connected to the server 202, performs a parse of the information. In the parse of the step 304, the various data types contained in the whole of the information are segregated into the particular types. The server 202 then manipulates the segregated data according to programming and choices for handling dictated at the server 202, for example, the separate sets of data of each type are assigned to respective queues 208 in a step 306 or otherwise treated at the server 202 in a step 310.

The step 310 can include a variety of different operations by or in connection with the server 202, corresponding to the particular data type of each set of segregated data from the parse step 304. If the data is representative of an image data type, such as, for example, a .gif or .jpg image of a Web page, the data can be handled differently than other data. For example, such image data may indicate an ad or banner of the Web page, and the treatment in the step 310 by the server 202 can be to discard the data or otherwise handle it.

If the data type from the parse step 304 is instead data that is to be forwarded by the server 202 to the client device 200, as is the usual case, each specific data type is assigned to is respective queue 208 of the server 202 in a step 306. The various queues 208 are separately maintained memory locations (or blocks of memory) of the server 202. Data of each specific data type received as part of the information is separately maintained in the memory that is the respective queue 208.

In a step 308, the server 202 sends the data of each queue 208 according to priority sequences set at the server 202. For example, the server 202 may be programmed or instructed, manually, automatically, or otherwise, to send data contained in a certain queue 208 prior to sending data of other queues 208. In certain embodiments, for example, text data or other data that is most important in priority to the wireless device 200 can be sent first. Thereafter, data of next priority contained in a next queue 208 is sent by the server 202 to the wireless device 200. Successive queues 208 are then sent by the server 202 in round-robin manner. Of course, the sequence of sending by virtue of the distinct queues 208 of the server 202 can be any succession or coordinated delivery, including, for example, data of certain queues 208 can be sent at the same time, sequences of priority can be changed at the server 202 or even by the wireless device 200 through communications to the server 202, and other sequences and steps of sending by the server, all according to the data types and the specific queues 208 for those types, is possible based on the programming and settings.

### Tokenization of HTML

Referring to FIG. 4, a tokenization server 400, for example, is included as the wireless ASP server computer 106. The tokenization server 400 serves to tokenize HTML or other code received or maintained at the tokenization server 400, for communication over the network, such as to the wireless device 200 over the Internet 102 including wireless channels. For purposes herein, the term “tokenization” refers to a process of representing larger amounts of data (such as sequences of commands or information) by a smaller data that identifies or is defined by the larger amount of data, the objective being to represent larger oft-recurring data sequences with smaller identifiers or terms for purposes of communications over networks. The tokenization server 400 receives information, such as over the Internet 102, from other devices connected to the Internet 102, for example, the server computer 104. The information received by the server 400 can be requested by the wireless device 200 or otherwise made available at the server 400 for delivery to the wireless device 200.

At the tokenization server 400, the information, such as an HTML page 402, is saved in a memory (not shown in detail), for example, RAM, cache or other memory. The HTML page 402 (or other information, as the case may be) is processed by the server 400 via a pre-processor 406. The pre-processor 406 is a software or hardware implemented manipulator of the HTML page 402, as hereinafter described more fully.

The preprocessor 406 includes, or alternately communicates with, a dictionary 404. The dictionary 404 is, for example, a relational database stored or accessible at the server 202 or some other listing associated with shortened or abbreviated terms. The dictionary 404 includes various HTML calls and sequences that are associated or related to other identifying data or terms. For example, certain HTML commands that may regularly occur in HTML or other served pages, such as the HTML page 402, can be represented by a more basic identifier or term, with the object being to limit the amount of data necessary to represent the commands. The preprocessor 406 reduces the HTML page 402 or other information to a tokenized HTML file 408 consisting of the reduced amount of data, including tokens, that represents the original HTML page 402 and its various commands and aspects.

The tokenized HTML file 408 is saved at the server 400. As appropriate for the server 400, for example, according to the previous descriptions of data type prioritization or otherwise, the tokenized HTML file 408 is communicated to the requesting device, i.e., the wireless device 200 in the embodiment. At the wireless device 200, the tokenized HTML file 408 is received and a separate dictionary (not shown) maintained at the wireless device 200 converts the tokenized HTML file 408 back to the original HTML page 402. The wireless device 200 can then handle the HTML page 402, in its full and original form, for example, by display at the wireless device 200 or other typical use for the particular type of information so communicated.

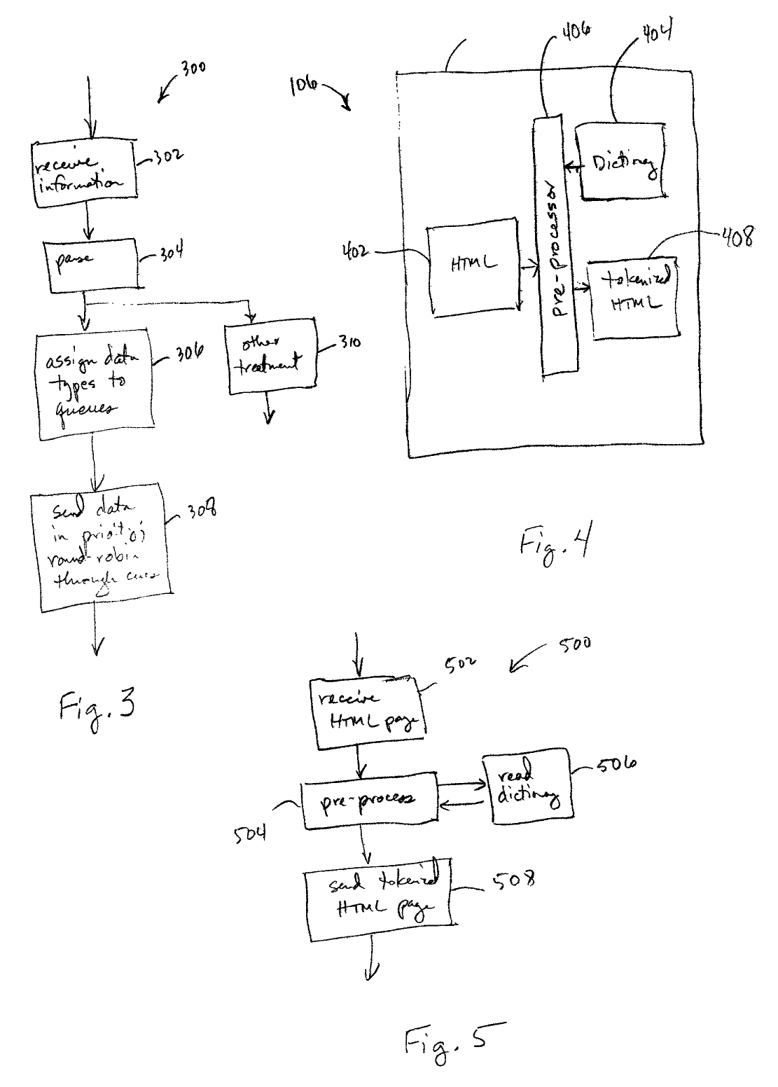

Referring to FIG. 5, a method 500 is performed by the tokenization server 400 of FIG. 4. In a step 502, the HTML page 402 (or other information, as the case may be) is received or otherwise available to the server 400. The server 400 next pre-processes the HTML page 402 in a step 504, by relating tokenized identifiers from the dictionary 404 to the data of the HTML page 402 and saving the tokenized HTML file 408 with tokens replacing certain sequences. Various read and write steps of a step 506 are involved in the tokenization performed in the pre-processing step 504. The result of the step 504 is the tokenized HTML file 408 which is smaller in size than the HTML page 402. Alternatively, the tokenized HTML file 408 could provide some benefit other than size reduction to the HTML page 402, for example, the pre-processing step 504 could tokenize in a manner that yields tokenized files that make communications over the network more expedient or reliable notwithstanding the tokenized file size and other factors.

In a step 508, the tokenized HTML file 408 is communicated by the server 400 over the network, such as a wireless channel, to the wireless device 200. The communications by the server 400, and the sequence and operations thereof, are as previously described or otherwise as conventional.

In operation of the systems 100, 200, 400 and the methods 300, 500, numerous alternative business and technical arrangements are possible. Of course, the wireless ASP server computer 106 must be capable of communicating via typical network protocols with other network connected devices in order to receive and deliver messages from and to those network connected devices, and then transfer those messages on or receive those messages from the wireless device 200, as appropriate. Moreover, although only particular devices of a communications network and its nodes are herein described and discussed, particularly, primarily the wireless device 200 and the wireless ASP server computer 106, the wired device 240 and the network 100, such as the Internet, have been described with regard to the embodiments, it is to be expressly understood that combinations of those elements, such as a plurality of any, certain ones, all of those elements, and even additional or alternative elements, is possible in keeping with the scope of the embodiments herein.

The network could be an intranet, or even an intranet combination or intranetextranet combination. Numerous banks of the wireless ASP server computer 106 can be possible for receiving communications from pluralities of wireless devices, and the wireless ASP server computers can be centrally located or distributed through a wide geographic area. In the case of a global network such as the Internet, the network is capable of communicating by its protocols, which may include other specialized protocols for specific situations.

The wireless ASP server computer in such instance can communicate with various devices on the network according to those other specialized protocols, if properly equipped as would be known to those skilled in the art. In general, the communications between the wireless device or devices and the wireless ASP server computer or computers occurs according to optimized protocols for wireless communications. These optimized protocols can be implemented entirely in software or alternatively can be hardware, combinations of hardware and software, or other mechanisms. The protocols of the hardware or software, as the case may be, for the wireless communications will, in any event, provide increased communications efficiency, speed, and adaptation for the wireless environment.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A communications network for communicating an information comprised of at least one data type, comprising:
a parser for parsing the information into distinct ones of each of the at least one data type;
queue for storing each distinct one of the at least one data type.

2. The communications network of claim 1, further comprising a client device communicatively connected to the queue for receiving the information communicated over the network.

3. The communications network of claim 2, further comprising a server including the parser and the queue; wherein the server transmits the data type of each queue in accordance with a predetermined priority sequence.

4. A method of prioritizing information communications according to data types of the information, comprising the steps of:
receiving the information; and
parsing the information to separate and segregate data types.

5. The method of claim 4, further comprising the steps of:
saving the separate data types in respective queues; and
sending the information in a prioritized sequence via the respective queues.

6. The method of claim 5, wherein the step of sending includes round-robin successive sending from each respective queue according to the prioritized sequence.

7. A method of communications, wherein a client device communicates with a server computer over a network, comprising the steps of:
receiving an information by the server computer;
pre-processing the information by replacing sequences of data of the information with pre-defined identifiers;
sending the information with the pre-defined identifiers substituted for the sequences of data.

8. The method of claim 7, further comprising the steps of.
receiving the information with the pre-defined identifiers substituted for the sequences of data; and
replacing the pre-defined identifiers with the sequences of data to obtain the information in original form.

9. The method of claim 7, where in the method is performed by a server computer communicatively connected to a client computer.

10. The method of claim 8, wherein the steps of receiving and replacing are performed by the client computer.

11. A server computer for receiving information including data sequences and for relating data sequences to defined identifiers, comprising:
a pre-processor for replacing data sequences of the information with defined identifiers.

12. The server computer of claim 11, further comprising:
a relational database of the defined identifiers.

13. The server computer of claim 12, wherein the information is an HTML page and the defined identifiers of the relational database include data sequences indicative of recurring HTML code sequences.
